(19) United States
(12) Patent Application Publication
(10) Pub. No.: US 2005/0219392 A1
(43) Pub. Date: Oct. 6, 2005

(54) Photoelectric conversion film-stacked type solid-state imaging device, method for driving the same and digital camera

(75) Inventor: Nobuo Suzuki, Kurokawa-gun (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/091,884

(22) Filed: Mar. 29, 2005

(30) Foreign Application Priority Data
Mar. 30, 2004 (JP) P.2004-098141

(51) Int. Cl. H04N 5/335

(52) U.S. Cl. 348/294

(57) ABSTRACT

To obtain high sensitivity image data in a dark scene, a solid-state imaging device includes: a semiconductor substrate; photoelectric conversion films stacked in a direction perpendicular to the semiconductor substrate, each converting an incident light to a signal charge; pixel electrode films on the photoelectric conversion films, each receiving the signal charge, the pixel electrode films being partitioned and arranged in an array in accordance with pixels, the array comprising units each comprising the pixel electrode films adjacent to one another; and a signal readout circuit in the semiconductor substrate in accordance with one of the units, the signal readout circuit comprising: pixel selection transistors each independently reading out the signal charge from one of the pixel electrode films; and an output transistor connecting to output portions in the pixel selection transistors, so that the signal readout circuit outputs an signal in accordance with the signal charge.

### FIELD OF THE INVENTION

The present invention relates to a photoelectric conversion film stacked-type solid-state imaging device in which photoelectric conversion films for generating charges in accordance with the intensity of received light are stacked on a semiconductor substrate, a method for driving the photoelectric conversion film-stacked type solid-state imaging device and a digital camera using the photoelectric conversion film-stacked type solid-state imaging device. Particularly it relates to a photo electric conversion film-stacked type solid-state imaging device in which signals in accordance with the amounts of signal charges generated by photoelectric conversion films are read out to the outside by transistor circuits formed in the semiconductor substrate, respectively, a method for driving the photoelectric conversion film-stacked type solid-state imaging device and a digital camera having the photoelectric conversion film-stacked type solid-state imaging device mounted therein.

### BACKGROUND OF THE INVENTION

In a CCD type solid-state imaging device or a CMOS type solid-state imaging device mounted in a digital camera, a large number of photoelectric conversion devices (photodiodes) serving as photo acceptance portions and signal readout circuits for reading out photoelectric conversion signals obtained by the photoelectric conversion devices to the outside are formed on a surface of a semiconductor substrate. In the CCD type solid-state imaging device, each of the signal readout circuits includes a charge transfer circuit, and a transfer electrode. In the CMOS type solid-state imaging device, each of the signal readout circuits includes an MOS circuit, and a signal wiring.

Accordingly, in the solid-state imaging device according to the related art, both the large number of photo acceptance portions and the signal readout circuits have to be formed together on the surface of the semiconductor substrate. There is a problem that the total area of the photo acceptance portions cannot be enlarged.

In addition, in a single plate type solid-state imaging device according to the related art, one of color filters, for example, of red (R), green (G) and blue (B) is stacked on each photo acceptance portion so that each photo acceptance portion can detect an optical signal with corresponding one of the colors. For this reason, for example, a blue optical signal and a green optical signal in a position of a photo acceptance portion for detecting red light are obtained by applying an interpolation operation on detection signals of surrounding photo acceptance portions for detecting blue light and green light. This causes false colors to thereby result in lowering of resolution. In addition, blue and green light beams incident on a photo acceptance portion covered with a red color filter are absorbed as heat to the color filter without giving any contribution to photoelectric conversion. For this reason, there is also another problem that light utilization efficiency deteriorates and sensitivity is lowered.

While the solid-state imaging device according to the related art has various problems as described above, development on increase in the number of pixels has advanced. At present, a large number of photo acceptance portions (e.g. equivalent to several million pixels) are integrated on one chip of a semiconductor substrate, so that the size of an aperture of each photo acceptance portion approaches the wavelength of light. Accordingly, it is difficult to expect a CCD type or CMOS type image sensor to have better image quality or sensitivity than ever to thereby solve the above mentioned problems.

Under such circumstances, the structure of a solid-state imaging device, for example, described in JP-A-58-103165 has been reviewed. The solid-state imaging device has a structure in which a photosensitive layer for detecting red light, a photosensitive layer for detecting green light and a photosensitive layer for detecting blue light are stacked on a semiconductor substrate having signal readout circuits formed in its surface, by a film-forming technique and in which these photosensitive layers are provided as photo acceptance portions so that photoelectric conversion signals obtained by the photosensitive layers can be taken out to the outside by the signal readout circuits. That is, the solid-state imaging device has a photoelectric conversion film-stacked type structure.

According to the structure, limitation on design of the signal readout circuits can be reduced greatly because it is unnecessary to provide any photo acceptance portion on the surface of the semiconductor substrate. Moreover, sensitivity can be improved because efficiency in utilization of incident light is improved. In addition, resolution can be improved because light with the three primary colors of red, green and blue can be detected from one pixel (one photo acceptance portion). The problem of false colors can be eliminated. The problems inherent to the CCD type or CMOS type solid-state imaging device according to the related art can be solved.

Therefore, photoelectric conversion film-stacked type solid-state imaging devices described in JP-A-2002-83946, JP-T-2002-502120, JP-T-2003-502841 and JP-B-3405099 have been proposed in recent years. An organic semiconductor or nano particles may be used as the material of each photosensitive layer.

In the photoelectric conversion film-stacked type solid-state imaging device, the photo acceptance portions need not be provided in the surface of the semiconductor substrate, so that a larger number of pixels can be attained compared with a CMOS type image sensor. Thus, the photoelectric conversion film-stacked type solid-state imaging device can capture an image with high resolution.

When a larger number of pixels are attained, the maximum number of electrons obtained each pixel, however, has to be reduced. Accordingly, in the case where an image of a very dark photographing scene is captured by use of the photoelectric conversion film-stacked type solid-state imaging device, there causes a problem that each output signal becomes too small and noise becomes relatively large to thereby result in an image with a poor S/N.

### SUMMARY OF THE INVENTION

An object of the invention is to provide a photoelectric conversion film-stacked type solid-state imaging device which is capable of capturing a high resolution image in a bright photographing scene while being capable of capturing a high sensitivity image in a dark photographing scene, and a digital camera in which the photoelectric conversion film-stacked type solid-state imaging device is mounted.

According to the invention, there is provided a solid-state imaging device including: a semiconductor substrate; at least one photoelectric conversion film stacked in a direction perpendicular to a surface of the semiconductor substrate, the at least one photoelectric conversion film each converting an incident light to a signal charge; a plurality of pixel electrode films on each of the at least one photoelectric conversion film, the pixel electrode films each receiving the signal charge, wherein the pixel electrode films are partitioned and arranged in an array in accordance with pixels, and the array comprises a plurality of units, each of the units comprising a plurality of the pixel electrode films adjacent to one another; and a signal readout circuit disposed in the semiconductor substrate in accordance with one of the units of the pixel electrode films, wherein the signal readout circuit comprises: a plurality of pixel selection transistors, the pixel selection transistors each independently reading out the signal charge from one of the pixel electrode films; and at least one output transistor connecting to output portions in the pixel selection transistors, so that the signal readout circuit outputs an image signal in accordance with the signal charge.

According to this configuration, high resolution image data can be obtained by reading out signals individually in accordance with signal charges of the respective pixels, and high sensitivity image data improved in sensitivity can be obtained by adding signal charges of the respective pixels.

The solid-state imaging device according to the invention may further include a charge drain unit for draining an excessive charge to each of the pixel selection transistors.

According to this configuration, it is possible to a void deterioration in image quality such as color mixture and lowering of saturated output.

In the solid-state imaging device according to the invention, the charge drain unit is provided as a charge drain transistor having a source connected to a connection portion for connecting one the pixel electrode films to a source of corresponding one of the pixel selection transistors, and a gate and a drain each connecting to a direct-current (DC) power supply.

According to this configuration, it is easy to manufacture the charge drain units.

In the solid-state imaging device according to the invention, the charge drain unit is a vertical overflow drain.

According to this configuration, the charge drain unit is disposed in the inside of the semiconductor substrate, so that scale of integration can be prevented from being reduced.

In the solid-state imaging device according to the invention, the photoelectric conversion films for performing photoelectric conversion in accordance with the incident light containing different color lights are stacked as a plurality of layers in the direction perpendicular to the surface of the semiconductor substrate; and the signal readout circuit includes output transistors for outputting different image signals from each other in accordance with color.

According to this configuration, it is possible to capture a color image, and it is possible to reduce the number of image signal output lines used for outputting image signals from the signal readout circuit.

In solid-state imaging device according to the invention, the photoelectric conversion films for performing photoelectric conversion in accordance with the incident lights containing different color lights are stacked as a plurality of layers in the direction perpendicular to the surface of the semiconductor substrate; and the signal readout circuit in includes one output transistor in accordance with one of the units of the pixel electrode films.

According to this configuration, it is further possible to reduce the number of image signal output lines used for reading out image signals from the signal readout circuit.

In the solid-state imaging device according to the invention, the photoelectric conversion films include a first photoelectric conversion film having a peak of spectral sensitivity characteristic at red, a second photoelectric conversion film having a peak of spectral sensitivity characteristic at green, and a third photoelectric conversion film having a peak of spectral sensitivity characteristic at blue.

According to this configuration, it is possible to capture a color image based on the three primary colors and it is possible to use an existing signal processing circuit for R (red color), G (green color) and B (blue color) signals.

In the solid-state imaging device according to the invention, the photoelectric conversion films further include a fourth photoelectric conversion film having a peak of spectral sensitivity characteristic at an intermediate color between blue and green.

According to this configuration, when a signal obtained by the fourth photoelectric conversion film is subtracted from a signal obtained by the first photoelectric conversion film, it is possible to obtain red in accordance with human's visibility.

According to the invention, there is provided a method of driving a solid-state imaging device, including selecting one of a high resolution readout mode and a high sensitivity readout mode so as to drive the solid-state imaging device, wherein the high resolution readout mode is a mode in which the at least one output transistor outputs the image signal in accordance with the signal charge from one of the pixels; and the high sensitivity readout mode is a mode in which the at least one output transistor outputs the image signal, the image signal is a sum amount of signal charges from a plurality of the pixels in one of the units of the pixel electrode films.

According to this configuration, it is possible to obtain high resolution image data in the high resolution readout mode, and it is possible to obtain high sensitivity image data in the high sensitivity readout mode.

According to the invention, there is provided a method of driving a solid-state imaging device, including selecting one of a high resolution readout mode and a high sensitivity readout mode to drive the solid-state imaging device, wherein the high resolution readout mode is a mode in which the one output transistors outputs the image signal in accordance with the signal charge from one of the pixels; and the high sensitivity readout mode is a mode in which the one output transistors outputs the image signal, the image signal is a sum amount of signal charges from a plurality of the pixels of a common color in one of the units of the pixel electrode films.

According to this configuration, it is possible to obtain high resolution color image data in the high resolution readout mode while it is possible to obtain high sensitivity color image data in the high sensitivity readout mode.

According to the invention, there is provided a digital camera including a solid-state imaging device described above, and a control unit for selecting one of the high resolution readout mode and the high sensitivity readout mode.

According to this configuration, it is possible to attain a digital camera which is capable of capturing a high resolution image in a bright scene while being capable of capturing a high sensitivity image in a dark scene.

According to the invention, it is possible to provide a solid-state imaging device which is capable of capturing a high resolution image in a bright photographing scene while being capable of capturing a high sensitivity image in a dark photographing scene, and a digital camera using the solid-state imaging device.

### BRIEF DESCRIPTION OF THE DRAWINGS

FIG. 1 is a block diagram of a digital camera in which a solid-state imaging device according to a first embodiment of the invention is mounted.

FIG. 2 is a typical view showing a surface of the solid-state imaging device shown in FIG. 1.

FIG. 3 is an enlarged typical view showing one of units in the solid-state imaging device depicted in FIG. 2.

FIG. 4 is a typical sectional view taken along the line IV-IV in FIG. 3.

FIG. 5 is a typical sectional view taken along the line V-V in FIG. 3.

FIG. 6 is a circuit configuration diagram of signal readout circuits in the solid-state imaging device according to the first embodiment of the invention.

FIGS. 7A and 7B are views for explaining an operation of the signal readout circuit depicted in FIG. 6 for reading out a signal in accordance with a high resolution readout mode.

FIGS. 8A and 8B are a view for explaining an operation of the signal readout circuit depicted in FIG. 6 for reading out a signal in accordance with a high sensitivity readout mode.

FIG. 9 is a circuit configuration diagram of a signal readout circuit in a solid-state imaging device according to a second embodiment of the invention.

FIG. 10 is a circuit configuration diagram of signal readout circuits in a solid-state imaging device according to a third embodiment of the invention.

FIG. 11 is a typical sectional view of main part of a semiconductor substrate of a solid-state imaging device according to a fourth embodiment of the invention.

### DETAILED DESCRIPTION OF THE INVENTION

An embodiment of the invention will be described below with reference to the drawings.

### First Embodiment

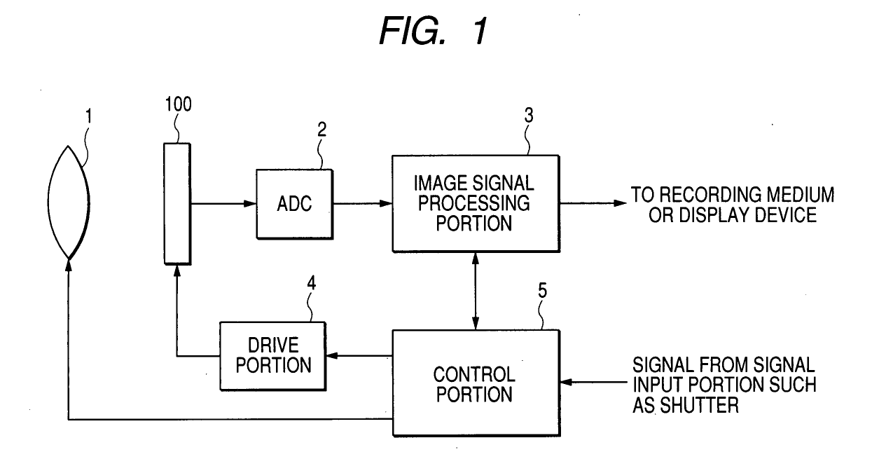

FIG. 1 is a block diagram of a digital camera in which a solid-state imaging device according to a first embodiment of the invention is mounted. The digital camera includes an image-forming optical system 1, a solid-state imaging device 100, an analog-to-digital converter 2, an image signal processing portion 3, a drive portion 4, and a control portion 5. The image-forming optical system 1 includes a photographic lens, an iris, and so on. The solid-state imaging device 100 will be described later in detail. The analog-to-digital converter 2 converts an analog image signal output from the solid-state imaging device 100 into a digital image signal. The image signal processing portion 3 performs image processing on the digital image signal and stores the processed image signal in a recording medium or displays the processed image signal on a display device. The drive portion 4 performs drive control on the solid-state imaging device 100. The control portion 5 takes in a signal from an operation portion such as a shutter button and controls the image signal processing portion 3, the drive portion 4 and the image-forming optical system 1.

When an analog-to-digital converter device is provided at the output stage of the solid-state imaging device 100 so as to be integrated with the solid-state imaging device 100, the analog-to-digital converter 2 can be dispensed with.

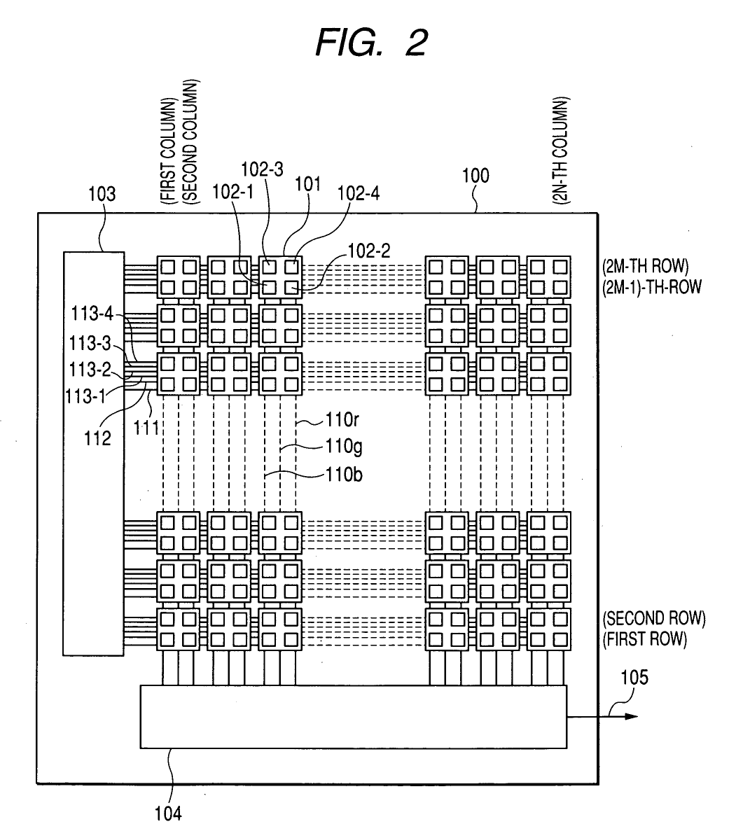

FIG. 2 is a typical view of a surface of the solid-state imaging device 100 shown in FIG. 1. The solid-state imaging device 100 includes a large number of photo acceptance portions 102 (each corresponding to a pixel) which is, for example, arranged in the form of a tetragonal lattice. In this embodiment, a plurality of units 101 are also arranged in the form of a tetragonal lattice so that each unit 101 is composed of four photo acceptance portions 102-1, 102-2, 102-3 and 102-4 adjacent to one another vertically and horizontally.

Signal readout circuits each constituted by an MOS transistor circuit which will be described later are formed in a surface of a semiconductor substrate provided under the units 101 of the solid-state imaging device 100.

Intra-unit photo acceptance portion selection signals (i.e., pixel election signals) through pixel election signal lines 113-1, 113-2, 113-3 and 113-4 as well as unit row selection signals through unit row selection signal lines 111 and reset signals through reset signal lines 112 are given from a row selection scanning circuit 103 to the signal readout circuits provided in accordance with the units 101. Column signals (image signals) through column signal lines (image signal lines) 110r, 110g and 110b are supplied from the signal readout circuits to an image signal output portion 104, so that output signals 105 are output from the image signal output portion 104. The image signal output portion 104 may output the taken-in image signals 1110r, 110g and 110b as analog signals or may convert the image signals 110r, 110g and 110b into digital signals and output the digital signals.

In this embodiment, each of the signal readout circuits outputs three column signals (i.e., red color signal, green color signal and blue color signal) simultaneously from corresponding one of the units 101 to the image signal output portion 103. Incidentally, a suffix r, g or b corresponds to red (R), green (G) or blue (B) which is the color of incident light to be detected. The same rule applies to the following description.

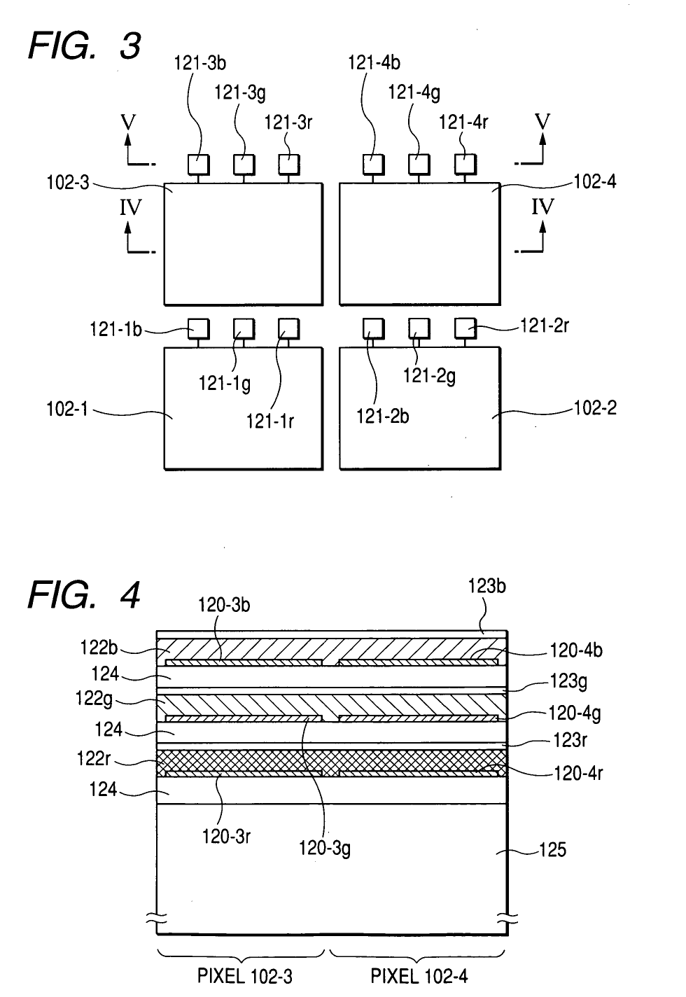

FIG. 3 is an enlarged typical view of one of the units 101 depicted in FIG. 2. Each of the units 101 has four photo acceptance portions 102-1, 102-2, 102-3 and 102-4 arranged in the form of a tetragonal lattice. The photo acceptance portions 102-1, 102-2, 102-3 and 102-4 are provided with three connection portions 121-1r, 121-1g and 121-1b, three connection portions 121-2r, 121-2g and 121-2b, three connection portions 121-3r, 121-3g and 121-3b and three connection portions 121-4r, 121-4g and 121-4b, respectively.

FIG. 4 is a typical sectional view taken along the line IV-IV in FIG. 3. A transparent insulator film 124 is first stacked on a semiconductor substrate 125. Electrode films (hereinafter referred to as pixel electrode films) 120-3r and 120-4r partitioned in accordance with the photo acceptance portions 102-3 and 102-4 is then stacked on the transparent insulator film 124. A photoelectric conversion film 122r for detecting red (R) is then stacked on the electrode film. The photoelectric conversion film 122r need not be partitioned in accordance with the photo acceptance portions. That is, the photoelectric conversion film 122r is stacked as a single sheet on the whole of a photo acceptance surface formed by a set of all the photo acceptance portions 102.

A common electrode film 123r which is common to the respective photo acceptance portions 102 for detecting red signals is stacked likewise as a single sheet on the photoelectric conversion film 122r. A transparent insulator film 124 is then stacked on the common electrode film 123r. Incidentally, the common electrode film 123r may be patterned so as to be partitioned in accordance with pixels in the same manner as the pixel electrode film. Because a common bias voltage is applied to these parts of the common electrode film 123r, a wiring portion for connecting adjacent ones of these parts of the common electrode film 123r has to remain when the common electrode film 123r is patterned.

Pixel electrode films 120-3g and 120-4g partitioned in accordance with the photo acceptance portions 102-3 and 102-4 is stacked on the insulator film 124. A photoelectric conversion film 122g for detecting green (G) is stacked as a single sheet on the pixel electrode film in the same manner as described above. A common electrode film 123g is then stacked on the photoelectric conversion film 122g. A transparent insulator film 124 is then stacked on the common electrode film 123g.

Pixel electrode films 120-3b and 120-4b partitioned in accordance with the photo acceptance portions 102-3 and 102-4 is stacked on the insulator film 124. A photoelectric conversion film 122b for detecting blue (B) is stacked as a single sheet on the pixel electrode film in the same manner as described above. A common electrode film 123b is then stacked on the photoelectric conversion film 122b.

Pixel electrode films 120-3b, 120-3g and 120-3r of the photo acceptance portion 102-3 are arranged in a line with respect to a direction of an incident light (i.e., substantially in a direction perpendicular to a surface of the semiconductor substrate). Similarly, pixel electrode films 120-4b, 120-4g and 120-4r of the photo acceptance portion 102-4 are arranged in a line with respect to the direction of the incident light. That is, the solid-state imaging device 100 according to this embodiment is configured so that the three colors of red (R), green (G) and blue (B) are detected by one photo acceptance portion 102-i (i=1 to 4). The simply described term “pixel” hereinafter means a photo acceptance portion 102-i for detecting the three colors whereas the described term “color pixel”, “red pixel”, “green pixel” or “blue pixel” means a partial pixel (i.e. a portion of a photoelectric conversion film sandwiched between a common electrode film and a pixel electrode film) for detecting corresponding one of the colors.

Each connection portion 121-ib (i=1 to 4, this rule applies hereinafter) shown in FIG. 3 is connected to a blue pixel electrode film part 120-ib. Each connection portion 121-ig is connected to a green pixel electrode film part 120-ig. Each connection portion 121-ir is connected to a red pixel electrode film part 120-ir.

A thin film of tin oxide (SnO₂), titanium oxide (TiO₂), indium oxide (InO₂) or indium titanium oxide (ITO) may be used as each of the homogeneous transparent electrode film parts 123r, 123g, 123b, 120-ir, 120-ig and 120-ib. The homogeneous transparent electrode film is not limited thereto.

A single layer film or a multilayer film maybe used as each of the photoelectric conversion films 122r, 122g and 122b. Various materials can be used as the materials of the photoelectric conversion films 122r, 122g and 122b. Examples of the materials include: inorganic materials such as silicon or compound semiconductor; organic materials containing organic semiconductor, organic pigment, etc.; and quantum dot-deposited films made from nano particles.

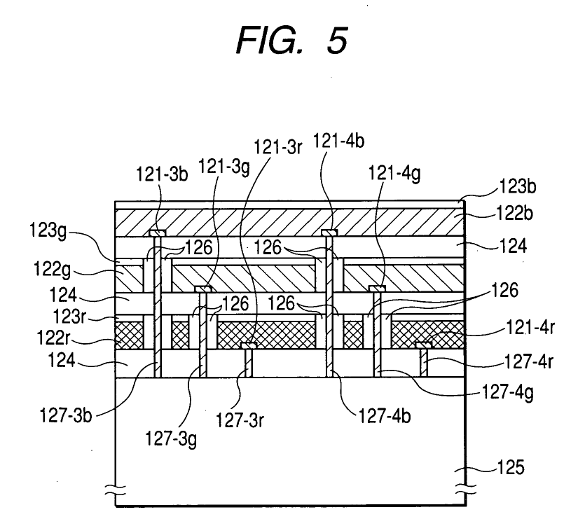

FIG. 5 is a typical sectional view taken along the line V-V in FIG. 3. A red signal connection portion of an MOS transistor circuit (which will be described later) formed on a semiconductor substrate and a connection portion 121-ir (i=1 to 4, especially, i=3 or 4 in the example of FIG. 5) connected to a red pixel electrode film 120-ir are connected to each other by a vertical wiring 127-ir. A green signal connection portion of the MOS transistor circuit (which will be described later) formed on the semiconductor substrate and a connection portion 121-ig connected to a green pixel electrode film 120-ig are connected to each other by a vertical wiring 127-ig. A blue signal connection portion of the MOS transistor circuit (which will be described later) formed on the semiconductor substrate and a connection portion 121-ib connected to a blue pixel electrode film 120-ib are connected to each other by a vertical wiring 127-ib.

Each of the vertical wirings 127-ir, 127-ig and 127-ib has a structure in which the vertical wiring prevents electrical connection between the connection portion 121-ir, 121-ig or 12l-ib and any other color signal connection portion than the corresponding color signal connection portion of the MOS transistor circuit. Therefore, insulator films 126 are applied to the surroundings of the vertical wirings 127-ig and 127-ib connected to the pixel electrode films 120-ig and 120-ib provided as upper layers.

Preferably, each of the vertical wirings 127-ig and 127-ib may be made of an optically transparent material. Preferably, the insulator films 126 may be made of a transparent material.

FIG. 6 is a circuit configuration diagram of signal readout circuits formed in a semiconductor substrate 125 and provided in accordance with each unit 101. The signal readout circuits includes a red signal readout circuit for reading out red signals from four red pixels in a unit 101, a green signal readout circuit for reading out green signals from four green pixels in the unit 101, and a blue signal readout circuit for reading out blue signals from four blue pixels in the unit 101. Because the respective color signal readout circuits have a common configuration, the configuration of the red signal readout circuit will be described here and the description about the green and blue signal readout circuits will be omitted while symbols g and b are only added to constituent members of the red signal readout circuit.

The red signal readout circuit has a charge detection cell 109r. The charge detection cell 109r includes an output transistor 115r, a unit row selection transistor 116r, and a reset transistor 117r. A source of the output transistor 115r is connected to a column signal line 110r. A gate of the output transistor 115r is connected to a source of the reset transistor 117r. A drain of the output transistor 115r is connected to a source of the unit row selection transistor 116r.

Both drains of the unit row selection transistor 116r and the reset transistor 117r are connected to a DC power supply line 114. Agate of the unit row selection transistor 116r is connected to a unit row selection signal line 111. A gate of there set transistor 117r is connected to a reset signal line 112.

The red signal readout circuit has four intra-unit pixel selection transistors (i.e., four pixel selection transistors in one unit) 118-1r, 118-2r, 118-3r and 118-4r in addition to the charge detection cell 109r. A gate of the transistor 118-1r is connected to an intra-unit pixel selection signal line 113-1. A source of the transistor 118-1r is connected to a red signal connection portion 119-1r of a photo acceptance portion 102-1 to which a vertical wiring 127-1r as described in FIG. 5 is connected. Similarly, a gate of the transistor 118-2r is connected to an intra-unit pixel selection signal line 113-2. A source of the transistor 118-2r is connected to a red signal connection portion 119-2r of a photo acceptance portion 102-2 to which a vertical wiring 127-2r as described in FIG. 5 is connected. A gate of the transistor 118-3r is connected to an intra-unit pixel selection signal line 113-3. A source of the transistor 118-3r is connected to a red signal connection portion 119-3r of a photo acceptance portion 102-3 to which a vertical wiring 127-3r as described in FIG. 5 is connected. A gate of the transistor 118-4r is connected to an intra-unit pixel selection signal line 113-4. A source of the transistor 118-4r is connected to a red signal connection portion 119-4r of a photo acceptance portion 102-4 to which a vertical wiring 127-4r as described in FIG. 5 is connected.

Drains of the four transistors 118-1r, 118-2r, 118-3r and 118-4r are connected in common to the gate of the output transistor 115r and the source of the reset transistor 117r.

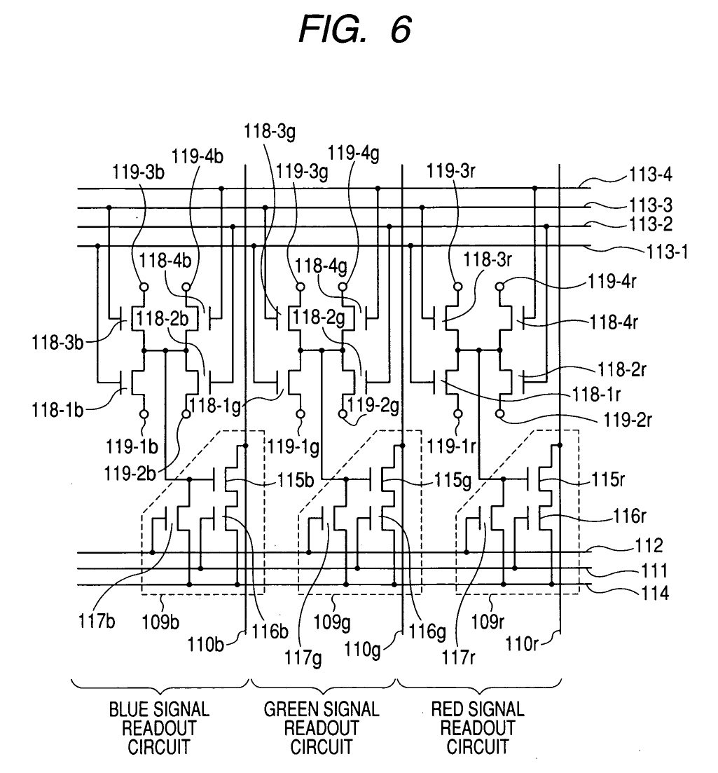

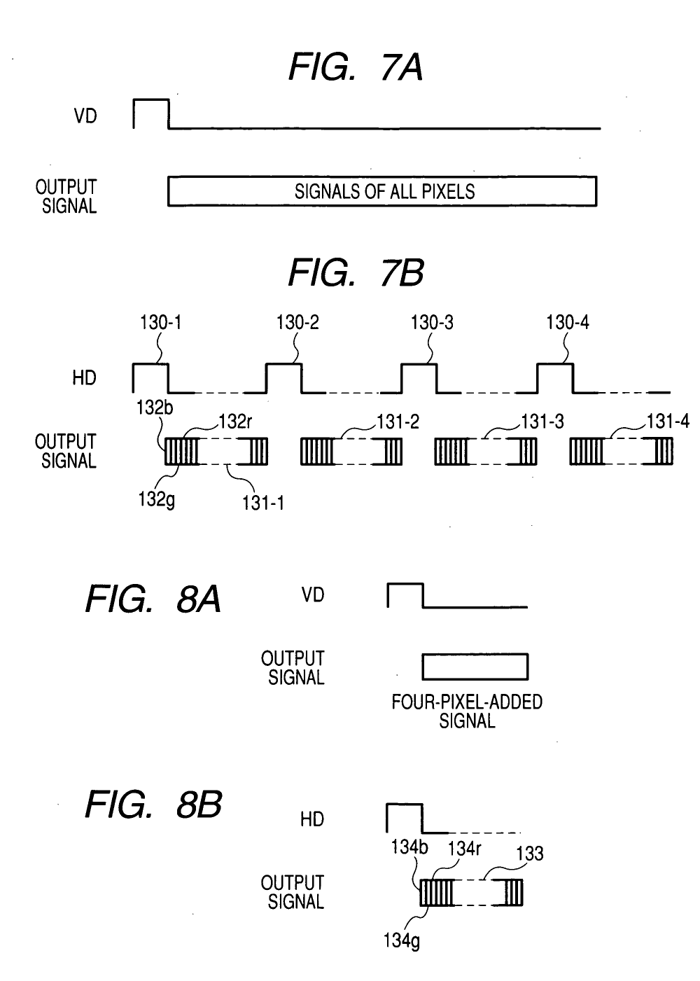

FIGS. 7A and 7B are views for explaining an operation (high resolution readout mode) when signals are read out individually and respectively from the photo acceptance portions 102-1, 102-2, 102-3 and 102-4 in each unit 101 by a signal readout circuit configured as described above.

FIG. 7A shows an output signal corresponding to one frame. FIG. 7B shows an output signal corresponding to one unit row. The symbol VD designates a vertical synchronizing pulse. The output signal corresponding to one unit row can be obtained by the following operation.

First, a readout unit row is selected in synchronism with a first horizontal synchronizing pulse HD 130-1 in accordance with a unit row selection signal of a unit row selection signal line 111. Successively, charge detection cells 109r, 109g and 109b in the selected unit row are reset in accordance with a reset signal of a reset signal line 112.

When an intra-unit pixel selection signal of an intra-unit pixel selection signal line 113-1 is then turned on, gates of intra-unit pixel selection transistors 118-1r, 118-1g and 118-1b of the first pixel (photo acceptance portion) 102-1 in the unit 101 are opened so that red signal charges are read out by the charge detection cell 109r, green signal charges are read out by the charge detection cell 109g and blue signal charges are read out to the charge detection cell 109b. Accordingly, signals in accordance with the amounts of the respective color signal charges are output to column signal lines 110r, 110g and 110b respectively.

Then, output signals 105 (132b, 132g and 132r in FIG. 7B) in accordance with the signals of the column signal lines 110b, 110g, 110r are output successively from the image signal output portion 104 (FIG. 2). The image signals are collectively designated by an output signal 131-1 shown in FIG. 7B.

Next, the charge detection cells 109r, 109g and 109b in the selected unit row are reset in synchronism with a second horizontal synchronizing pulse HD 130-2 in accordance with a reset signal of a reset signal line 112. Successively, red signal charges, green signal charges and blue signal charge of the second pixel 102-2 in the unit 101 are read out by the corresponding charge detection cells 109r, 109g and 109b in accordance with an intra-unit pixel selection signal of an intra-unit pixel selection signal line 113-2. The charge detection cells 109r, 109g and 109b output signals in accordance with the amounts of the signal charges to the column signal lines 110-r, 110-g and 110-b respectively. Then, an output signal 131-2 in accordance with signals of the column signal lines 110r, 110g and 110b is output from the image signal output portion 104.

The same operation as described above is repeated so that output signals 131-3 and 131-4 in accordance with signal charges of the third and fourth pixels 102-3 and 102-4 in the unit are output. All signal charges of the four pixels 102-i in one unit row can be read out by this operation.

The output signal 131-i forms a time-series column signal having repetition (132b, 132g and 132r) of blue (B), green (G) and red (R). The operation of reading out one unit row is repeated for respective rows successively. As a result, output signals of all pixels in one frame are obtained. Because the photo acceptance portions 102 are arranged in the form of a matrix having 2M rows and 2N columns in the case of the solid-state imaging device 100 depicted in FIG. 2, the total number of signals is 3×(2M)×(2N). When the output signals are subjected to image signal processing, a high resolution image can be obtained.

FIGS. 8A and 8B are views for explaining an operation (high sensitivity readout mode) when an image of a dark photographing scene is captured. FIG. 8A shows an output signal corresponding to one frame. FIG. 8B shows an output signal corresponding to one unit row. The symbol VD designates a vertical synchronizing pulse. The output signal corresponding to one unit row can be obtained by the following operation.

First, a readout unit row is selected in synchronism with a horizontal synchronizing pulse HD in accordance with a unit row selection signal of a unit row selection signal line 111. Successively, charge detection cells 109r, 109g and 109b in the selected unit row are reset in accordance with a reset signal of a reset signal line 112.

Then, intra-unit pixel selection signals of intra-unit pixel selection signal lines 113-1 to 113-4 are turned on simultaneously or turned on continuously and successively in a short time. In this manner, in each red signal readout circuit, four transistors 118-1r to 118-4r are electrically conducted so that signal charges of pixels of a common color in the unit 101 are read out to the gate portion of the output transistor 115r of a corresponding charge detection cell 109r. That is, signal charges of four red pixels are added and a signal in accordance with the amount of the added charges is output to the column signal line 110r.

Similarly, in each green signal readout circuit, signal charges read out from four green pixels are read out to the gate portion of the output transistor 115g of a corresponding charge detection cell 109g so as to be added. A signal in accordance with the amount of the added charges is output to the column signal line 110g.

Similarly, in each blue signal readout circuit, signal charges read out from four blue pixels are read out to the gate portion of the output transistor 115b of a corresponding charge detection cell 109b so as to be added. A signal in accordance with the amount of the added charges is output to the column signal line 110b.

Then, output signals 133 in accordance with signals of the column signal lines 110b, 110g and 110r are output successively from the image signal output portion 104. The output signals 133 form a time-series signal having repetition of signals 134b and 134g and 134r of blue (B), green (G) and red (R).

Each of the output signals is a signal obtained by adding signal charges of four pixels of a common color. That is, each of the output signals is a signal with four-fold sensitivity. When the output signals are subjected to image signal processing, an image with four-fold sensitivity can be obtained. In the high sensitivity readout mode, the total number of output signals is 3×M×N and is equal to ¼ as large as the total number of output signals when all the pixels are read out. Although image resolution is reduced thus, an image with four-fold sensitivity and high S/N can be obtained. This embodiment is particularly effective in capturing an image of a dark scene.

Although the first embodiment has been described on the case where only the operation of adding four pixels in the high sensitivity readout mode is performed, for example, a signal with two-fold sensitivity may be obtained if signal charges of a first pixel in a unit 101 and signal charges of a second pixel in the unit 101 are read out and added. That is, an output signal with high sensitivity such as two-fold, three-fold or four-fold sensitivity can be obtained if the image selection signal in one unit 101 can be selected suitably.

Although the first embodiment has been described on the case where the number of pixels in one unit 101 is set at 2×2, it is a matter of course that each unit may include an arbitrary number, I×J, of pixels (in which I and J are positive integers except I=J=1), such as 3×3 pixels, 3×4 pixels or 4×3 pixels. In this case, output signals with high sensitivity ranging from two-fold sensitivity to (I×J)-fold sensitivity can be obtained.

Incidentally, the control portion 5 shown in FIG. 1 makes a judgment, based on a detection signal from any one of various sensors or an instruction input from a user, as to whether color image signals are to be read out from the solid-state imaging device 100 in the high resolution readout mode or in the high sensitivity readout mode. The control portion 5 controls the drive portion 4 to read out the color image signals from the solid-state imaging device 100 in accordance with the mode selected on the basis of the judgment.

### Second Embodiment

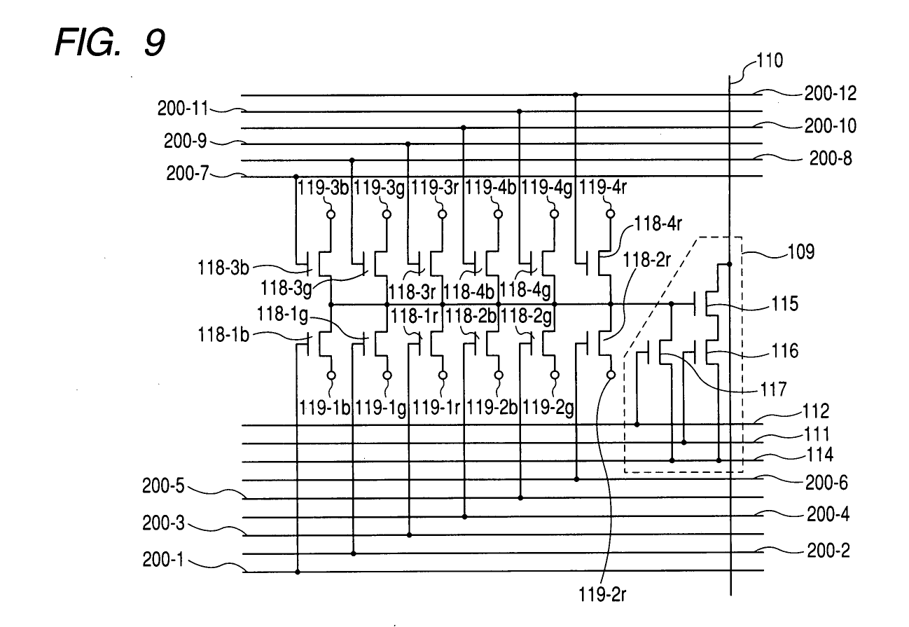

FIG. 9 is a circuit configuration diagram of a signal readout circuit of a photoelectric conversion film lamination type solid-state imaging device according to a second embodiment. The configuration of the second embodiment is the same as that of the first embodiment except the configuration of each signal readout circuit.

In the first embodiment, the signal readout circuit as shown in FIG. 6 is configured so that red, green and blue signals are read out simultaneously while the signal readout circuit is divided into a red signal charge detection cell 109r, a green signal charge detection cell 109g and a blue signal charge detection cell 109b (i.e., a signal read out circuit corresponding to one unit 101 includes a plurality of output transistors). The second embodiment is different from the first embodiment in that a charge detection cell 109 is provided in common for respective colors and drains of twelve intra-unit pixel selection transistors 118-ir, 118-ig and 118-ib in total connected in common to a connection portion between a gate of an output transistor 115 and a source of a reset transistor 117 in the charge detection cell 109 (i.e., a signal read out circuit corresponding to one unit 101 includes one output transistor).

Due to the configuration made thus, the number of intra-unit pixel selection signal lines is increased to twelve, that is, lines 200-1 to 200-12. It is however not difficult to manufacture the solid-state imaging device 100 because these signal lines can be connected to the unit row selection scanning circuit 102 by multilayer metal wiring.

When the high resolution readout mode is to be executed in the photoelectric conversion film lamination type solid-state imaging device 100 having the signal readout circuit configured thus, twelve intra-unit pixel selection signals of intra-unit pixel selection signal lines 200-1 to 200-12 are applied to the transistors 118-ir, 118-ig and 118-ib successively and respectively in synchronism with a horizontal synchronizing signal so that these signals of intra-unit pixel selection signal lines 200-1 to 200-12 are read out. When this operation is repeated in the sequence of unit rows, image signals with high resolution can be obtained.

When the solid-state imaging device 100 is to be operated in the high sensitivity readout mode in which every four pixels are added, intra-unit pixel selection signals of intra-unit pixel selection signal lines 200-1, 200-4, 200-7 and 200-10 are applied simultaneously to corresponding transistors 118-ir (or applied to corresponding transistors 118-ir successively in a short time) in synchronism with a first horizontal synchronizing pulse. Thus, four-pixel-added signal charges of blue are read out to the gate portion of the outer transistor 115 of the charge detection cell 109. A signal in accordance with the amount of the four-pixel-added signal charges is output to the image signal output portion 104 through a column signal line 110. The four-pixel-added signal is then output from the image signal output portion 104 to the outside.

Next, intra-unit pixel selection signals of intra-unit pixel selection signal lines 200-2, 2002-5, 2002-8 and 2002-11 are applied simultaneously (or applied successively in a short time) in synchronism with a second horizontal synchronizing pulse, so that four-pixel-added signal charges of green are read out to the gate portion of the output transistor 115 of the charge detection cell 109. A signal in accordance with the amount of the four-pixel-added signal charges is output to the image signal output portion 104 through the column signal line 110. The four-pixel-added signal is then output from the image signal output portion 104 to the outside.

Then, intra-unit pixel selection signals of intra-unit pixel selection signal lines 200-3, 200-6, 200-9 and 200-12 are applied simultaneously (or applied successively in a short time) in synchronism with a third horizontal synchronizing pulse, so that a four-pixel-added signal of red is output in the same manner as described above.

When the aforementioned operation is repeated in the sequence of unit rows, color image signals with four-fold sensitivity are output. In this embodiment, the number of intra-unit pixel selection signal lines is increased from four to twelve but there is an advantage to the first embodiment in that the number of intra-unit transistors is reduced from twenty one to fifteen.

### Third Embodiment

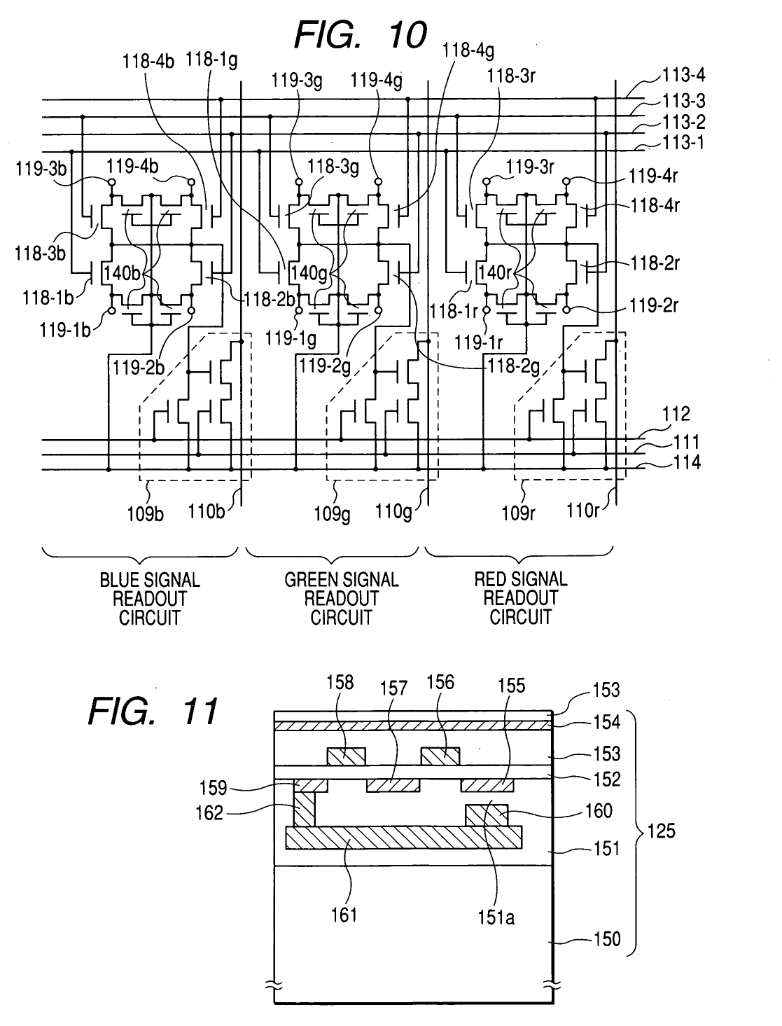

FIG. 10 is a circuit configuration diagram of a signal readout circuit according to a third embodiment of the invention. The configuration of the third embodiment is the same as that of the first or second embodiment except the configuration of the signal readout circuit.

The first or second embodiment may cause the following disadvantage. To capture a still image, a mechanical shutter has to be used. If an image signal is output after the mechanical shutter is closed after the image capturing, there is no problem. A problem will be, however, caused when the mechanical shutter cannot be used, for example, when a motion picture is captured.

In the state where signal charges in a certain color pixel become excessive because of a very bright subject, the excessive charges flow into a gate of an output transistor through a pixel selection transistor. Because the excessive charges are added to any other color signal, color mixture may occur to thereby result in deterioration in image quality.

Such excessive charges may also occur just after resetting. A signal just after resetting is a reference signal in a zero signal state. The level of the reference signal becomes large. For this reason, there occurs a phenomenon that the level of a saturated output signal is reduced by the excess of charges flowing into the reference signal. When an image of a very bright spherical electric bulb is captured, it will become an unnatural image because a very bright center portion of the image becomes black.

Therefore, the signal readout circuit according to the third embodiment is different from the signal readout circuit (FIG. 6) according to the first embodiment in that twelve charge drain transistors 140r, 140g and 140b in total are added in accordance with intra-unit pixel selection transistors.

Sources of four charge drain transistors 140r in a red signal readout circuit are connected to connection portions 119-ir to which sources of corresponding intra-unit pixel selection transistors 118-ir are connected, respectively. Gates and drains of the four charge drain transistors 140r in the red signal readout circuit are connected to a DC power supply line 114. Connection of charge drain transistors 140g or 140b in a green or blue signal readout circuit is the same as that in the red signal readout circuit.

Film thicknesses of the gates of the charge drain transistors 140r, 140g and 140b and impurity density of the surface of the semiconductor substrate under the gates are selected so that excessive charges generated in color pixels in one unit 101 are prevented from flowing out to the gates of the output transistors of the charge detection cells 109r, 109g and 109b through the intra-unit pixel selection transistors 118-ir, 118-ig and 118-ib, and that the excessive charges are drained to the drains of the charge drain transistors 140r, 140g and 140b.

In this manner, excessive charges generated in the respective color pixels are drained to the DC power supply line 114 after passing through channels under the gates of the charge drain transistors 140r, 140g and 140b, so that generation of a saturated output lowering phenomenon can be prevented.

### Fourth Embodiment

FIG. 11 is a typical sectional view of main part of an MOS transistor portion provided in a semiconductor substrate of a solid-state imaging device according to a fourth embodiment of the invention.

A P-well layer 151 is formed on a surface portion of an n-type semiconductor substrate 150. A source (n⁺ region) 155 of an intra-unit pixel selection transistor 118, a region 157 serving as a drain (n⁺ region) of the intra-unit pixel selection transistor 118 and also as a source (n⁺ region) of a reset transistor 117, and a drain (n⁺ region) 159 of the reset transistor 117 are formed in a surface portion of the P-well layer 151. The region 157 is electrically connected to a gate of an output transistor 115.

A gate insulator film 152 is formed on the surfaces of the regions 155, 157 and 159. On the gate insulator film 152, a gate 156 of the intra-unit pixel selection transistor 118 for connecting the regions 155 and 157 to each other is formed and a gate 158 of the reset transistor 117 for connecting the regions 157 and 159 to each other is formed.

An insulator film 153 is stacked on the surface of the gate insulator film 152 and flattened. Inside the insulator film 153, a light shielding film 154 is stacked and an insulator film 124 which is the lowest layer as shown in FIG. 5 is stacked thereon.

In the P-well layer 151 according to the embodiment, an n-type semiconductor region 160 separated from the region 155 is formed under the region 155 by ion implantation or the like. The n-type semiconductor region 160 is connected to the drain 159 of the reset transistor 117 through n-layer regions 161 and 162.

The n-type semiconductor region 160 serves as an overflow drain and is electrically connected to the DC power supply line 114 through the drain of the reset transistor 117.

When excessive charges enter the drain 155 in the condition that a P-well layer portion 151a near the overflow drain 160 is depleted, the excessive charges pass through the depleted portion 151a and are drained to the overflow drain 160. The excessive charges are drained from the regions 161 and 162 to the DC power supply line 114 through the drain of the reset transistor 117. Accordingly, in this embodiment, deterioration in image quality such as color mixture and lowering in the saturated output can be prevented.

Although the respective embodiments have been described on the case where the charge detection cell has such a circuit configuration that a DC power supply line, a row selection transistor, an output transistor and a column signal line are connected in this order, the invention may be applied to the case where the charge detection cell has such a circuit configuration that a DC power supply line, an output transistor, a row selection transistor and a column signal line are connected in this order.

Although the respective embodiments have been described on the case where the photoelectric conversion films are provided as three layers so that incident light is detected while the color of the incident light is separated into the three primary colors of R, G and B, the invention may be applied to the case where, for example, a fourth photoelectric conversion film for detecting an intermediate color between green and blue besides R, G and B is additionally provided so that incident light is detected while the color of the incident light is separated into four colors. In this case, color reproducibility can be improved because color separation can be made more finely.

Although the embodiments have been described on the case where the photoelectric conversion films for detecting blue, green and red incident light components are provided in increasing order of wavelength viewed from above the solid-state imaging device, the arrangement sequence of photoelectric conversion films is not limited thereto. Although a common electrode film and a corresponding pixel electrode film are provided so that each photoelectric conversion film is sandwiched between the common electrode film and the corresponding pixel electrode film, the common electrode film need not be provided on the upper side of the photoelectric conversion film, that is, the common electrode film may be provided on the, lower side of the photoelectric conversion film.

Although each of all the pixel electrode films and common electrode films is made of a transparent or low-light-absorption material, only the electrode film nearest to the semiconductor substrate may be made of an opaque material.

Although the description of the respective embodiments has not touched on the subject about an electron shutter, it is a matter of course that the same electron shutter function as that of a general CMOS type image sensor can be given to the invention.

Although the respective embodiments have been described on the case where signal charges of all the pixels are read out in the high resolution readout mode or the high sensitivity readout mode, it is a matter of course that readout pixels may be thinned without reading out signal charges of part of the pixels in order to achieve a high speed frame rate.

Because the solid-state imaging device according to the invention can output high sensitivity image data even if increase in the number of pixels is intended, the solid-state imaging device according to the invention is useful when mounted in a digital camera.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

The present application claims foreign priority based on Japanese Patent Application No. JP2004-98141, filed Mar. 30, 2004, the contents of which is incorporated herein by reference.

1. A solid-state imaging device comprising:
a semiconductor substrate;
at least one photoelectric conversion film stacked in a direction perpendicular to a surface of the semiconductor substrate, the at least one photoelectric conversion film each converting an incident light to a signal charge;
a plurality of pixel electrode films on each of the at least one photoelectric conversion film, the pixel electrode films each receiving the signal charge, wherein the pixel electrode films are partitioned and arranged in an array in accordance with pixels, and the array comprises a plurality of units, each of the units comprising a plurality of the pixel electrode films adjacent to one another; and
a signal readout circuit disposed in the semiconductor substrate in accordance with one of the units of the pixel electrode films, wherein the signal readout circuit comprises: a plurality of pixel selection transistors, the pixel selection transistors each independently reading out the signal charge from one of the pixel electrode films; and at least one output transistor connecting to output portions in the pixel selection transistors, so that the signal readout circuit outputs an image signal in accordance with the signal charge.

2. The solid-state imaging device according to claim 1, which further comprises a charge drain unit that drains an excessive charge in each of the pixel selection transistors.

3. The solid-state imaging device according to claim 2, wherein the charge drain unit is a transistor comprising: a source that connects to a portion connecting one of the pixel electrode films to a source in one of the pixel selection transistors; a gate; and a drain, each of the gate and the drain connecting to a direct-current power supply.

4. The solid-state imaging device according to claim 2, wherein the charge drain unit is a vertical overflow drain.

5. The solid-state imaging device according to claim 1, which includes a plurality of photoelectric conversion films photoelectrically converting different color lights in contained the incident light,
wherein the signal readout circuit includes a plurality of output transistors outputting different image signals from each other in accordance with color.

6. The solid-state imaging device according to claim 5, wherein the photoelectric conversion films include: a first photoelectric conversion film having a peak of spectral sensitivity characteristic at red; a second photoelectric conversion film having a peak of spectral sensitivity characteristic at green; and a third photoelectric conversion film having a peak of spectral sensitivity characteristic at blue.

7. The solid-state imaging device according to claim 6, wherein the photoelectric conversion films further include a fourth photoelectric conversion film having a peak of spectral sensitivity characteristic at an intermediate color between blue and green.

8. The solid-state imaging device according to claim 1, which includes a plurality of photoelectric conversion films photoelectrically converting different color lights in contained the incident light,
wherein the signal readout circuit includes one output transistor.

9. The solid-state imaging device according to claim 8, wherein the photoelectric conversion films include: a first photoelectric conversion film having a peak of spectral sensitivity characteristic at red; a second photoelectric conversion film having a peak of spectral sensitivity characteristic at green; and a third photoelectric conversion film having a peak of spectral sensitivity characteristic at blue.

10. The solid-state imaging device according to claim 9, wherein the photoelectric conversion films further include a fourth photoelectric conversion film having a peak of spectral sensitivity characteristic at an intermediate color between blue and green.

11. A method of driving a solid-state imaging device according to claim 1, which comprises selecting one of a high resolution readout mode and a high sensitivity readout mode so as to drive the solid-state imaging device,
wherein the high resolution readout mode is a mode in which the at least one output transistor outputs the image signal in accordance with the signal charge from one of the pixels; and
the high sensitivity readout mode is a mode in which the at least one output transistor outputs the image signal, the image signal is a sum amount of signal charges from a plurality of the pixels in one of the units of the pixel electrode films.

12. A method of driving a solid-state imaging device according to claim 5, which comprises selecting one of a high resolution readout mode and a high sensitivity readout mode so as to drive the solid-state imaging device,
wherein the high resolution readout mode is a mode in which each of the output transistors outputs the image signal in accordance with the signal charge from one of the pixels; and
the high sensitivity readout mode is a mode in which at least one of the output transistors outputs the image signal, the image signal is a sum amount of signal charges from a plurality of the pixels of a common color in one of the units of the pixel electrode films.

13. A method of driving a solid-state imaging device according to claim 8, which comprises selecting one of a high resolution readout mode and a high sensitivity readout mode so as to drive the solid-state imaging device,
wherein the high resolution readout mode is a mode in which the one output transistor outputs the image signal in accordance with the signal charge from one of the pixels; and
the high sensitivity readout mode is a mode in which the one output transistor outputs the image signal, the image signal is a sum amount of signal charges from a plurality of the pixels of a common color in one of the units of the pixel electrode films.

14. A digital camera comprising:
a solid-state imaging device according to claim 1; and
a control unit that selects one of a high resolution readout mode and a high sensitivity readout mode so as to drive the solid-state imaging device,
wherein the high resolution readout mode is a mode in which the at least one output transistor outputs the image signal in accordance with the signal charge from one of the pixels; and
the high sensitivity readout mode is a mode in which the at least one output transistor outputs the image signal, the image signal is a sum amount of signal charges from a plurality of the pixels in one of the units of the pixel electrode films.

15. A digital camera comprising:
a solid-state imaging device according to claim 5; and
a control unit that selects one of a high resolution readout mode and a high sensitivity readout mode so as to drive the solid-state imaging device,
wherein the high resolution readout mode is a mode in which each of the output transistors outputs the image signal in accordance with the signal charge from one of the pixels; and
the high sensitivity readout mode is a mode in which at least one of the output transistors outputs the image signal, the image signal is a sum amount of signal charges from a plurality of the pixels of a common color in one of the units of the pixel electrode films.

16. A digital camera comprising:
a solid-state imaging device according to claim 8; and
a control unit that selects one of a high resolution readout mode and a high sensitivity readout mode so as to drive the solid-state imaging device,
wherein the high resolution readout mode is a mode in which the one output transistor outputs the image signal in accordance with the signal charge from one of the pixels; and
the high sensitivity readout mode is a mode in which the one output transistor outputs the image signal, the image signal is a sum amount of signal charges from a plurality of the pixels of a common color in one of the units of the pixel electrode films.
